(19) United States
(12) Patent Application Publication
(10) Pub. No.: US 2021/0333384 A1
(43) Pub. Date: Oct. 28, 2021

(54) THREE-DIMENSIONAL RECONSTRUCTION DEVICE, THREE-DIMENSIONAL RECONSTRUCTION SYSTEM, THREE-DIMENSIONAL RECONSTRUCTION METHOD, AND STORAGE MEDIUM STORING THREE-DIMENSIONAL RECONSTRUCTION PROGRAM

(71) Applicant: MITSUBISHI ELECTRIC CORPORATION, Tokyo (JP)

(72) Inventors: Kento YAMAZAKI, Tokyo (JP); Kohei OKAHARA, Tokyo (JP); Jun MINAGAWA, Tokyo (JP); Shinji MIZUNO, Aichi (JP); Shintaro SAKATA, Aichi (JP); Takumi SAKAKIBARA, Aichi (JP)

(73) Assignee: MITSUBISHI ELECTRIC CORPORATION, Tokyo (JP)

(21) Appl. No.: 17/371,374

(22) Filed: Jul. 9, 2021

Related U.S. Application Data
(63) Continuation of application No. PCT/JP2019/018759, filed on May 10, 2019.

(30) Foreign Application Priority Data
Jan. 16, 2019 (JP) 2019-004819

(51) Int. Cl. G01S 13/42; G01S 13/89

(52) U.S. Cl. CPC G01S 13/426; G01S 13/89

(57) ABSTRACT

A three-dimensional reconstruction device includes processing circuitry, to acquire first three-dimensional information representing a target object from a first sensor generating the first three-dimensional information by detecting the target object that is moving and to acquire second three-dimensional information representing an attention part of the target object from a second sensor generating the second three-dimensional information by detecting the attention part; to acquire first sensor information and second sensor information; to acquire first position posture information indicating a position and posture of the first sensor and to acquire second position posture information indicating a position and posture of the second sensor; and to reconstruct the three-dimensional information representing the attention part from the first three-dimensional information and the second three-dimensional information by using the first sensor information, the second sensor information, the first position posture information and the second position posture information.

### CROSS-REFERENCE TO RELATED APPLICATIONS

This application is a continuation application of International Application No. PCT/JP2019/018759 having an international filing date of May 10, 2019, which claims priority to Japanese Patent Application No. 2019-004819 filed on Jan. 16, 2019.

### BACKGROUND OF THE INVENTION

### 1. Field of the Invention

The present invention relates to a three-dimensional reconstruction device, a three-dimensional reconstruction system, a three-dimensional reconstruction method and a three-dimensional reconstruction program.

### 2. Description of the Related Art

There has been proposed a system that reconstructs three-dimensional information regarding a target object existing in real space by using a plurality of pieces of real space information acquired by a plurality of sensors (see Non-patent Reference 1, for example). The plurality of sensors are a plurality of Kinects, for example. The Kinect is a registered trademark of Microsoft Corporation. The Kinect is an example of a motion capture device. The real space information acquired by each sensor is, for example, depth information indicating the distance from the sensor to the target object. The reconstructed three-dimensional information is integrated spatial information generated by integrating the plurality of pieces of real space information acquired by the sensors.
Non-patent Reference 1: Marek Kowalski and two others, “Livescan3D: A Fast and Inexpensive 3D Data Acquisition System for Multiple Kinect v2 Sensors”

However, in order to correctly grasp a situation in the real space, it is necessary to broadly grasp the whole of the situation and grasp an attention part in detail. However, the attention part has a possibility of moving, and thus even if a plurality of sensors are set, there is a danger of a lack of information necessary for grasping the situation due to deviation of the attention part from a detectable range or insufficiency of resolution. While it is conceivable to additionally set sensors along moving paths of the attention part to decrease the occurrence of such situations, there is a problem in that the cost for the system rises due to the additional setting of the sensors.

### SUMMARY OF THE INVENTION

An object of the present invention, which has been made to resolve the above-described problem with the conventional technology, is to provide a three-dimensional reconstruction device and a three-dimensional reconstruction system capable of reconstructing the three-dimensional information representing the attention part at a low cost and a three-dimensional reconstruction method and a three-dimensional reconstruction program used for reconstructing the three-dimensional information representing the attention part at a low cost.

A three-dimensional reconstruction device according to an aspect of the present invention includes processing circuitry to acquire first three-dimensional information representing a target object from a first sensor arranged at a predetermined position and generating the first three-dimensional information by detecting the target object that is moving and to acquire second three-dimensional information representing an attention part of the target object from a second sensor provided to be movable and generating the second three-dimensional information by detecting the attention part; to acquire first sensor information indicating a property intrinsic to the first sensor and second sensor information indicating a property intrinsic to the second sensor; to acquire first position posture information indicating a position and posture of the first sensor and to acquire second position posture information indicating a position and posture of the second sensor; and to reconstruct the three-dimensional information representing the attention part from the first three-dimensional information and the second three-dimensional information by using the first sensor information, the second sensor information, the first position posture information and the second position posture information.

A three-dimensional reconstruction method according to another aspect of the present invention includes acquiring first three-dimensional information representing a target object from a first sensor that is arranged at a predetermined position and generates the first three-dimensional information by detecting the target object that is moving; acquiring second three-dimensional information representing an attention part of the target object from a second sensor that is provided to be movable and generates the second three-dimensional information by detecting the attention part; acquiring first sensor information indicating a property intrinsic to the first sensor; acquiring second sensor information indicating a property intrinsic to the second sensor; acquiring first position posture information indicating a position and posture of the first sensor; acquiring second position posture information indicating a position and posture of the second sensor; and reconstructing the three-dimensional information representing the attention part from the first three-dimensional information and the second three-dimensional information by using the first sensor information, the second sensor information, the first position posture information and the second position posture information.

According to the present invention, an advantage is obtained in that the three-dimensional information necessary for grasping a situation in the space can be reconstructed at a low cost.

### BRIE DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a diagram schematically showing an example of arrangement of a plurality of sensors that provide a three-dimensional reconstruction device according to a first embodiment of the present invention with three-dimensional information as real space information and a target object existing in real space;

FIG. 2 is a diagram schematically showing another example of the arrangement of the plurality of sensors that provide the three-dimensional reconstruction device according to the first embodiment with the three-dimensional information and the target object existing in the real space;

FIG. 3 is a diagram schematically showing another example of the arrangement of the plurality of sensors that provide the three-dimensional reconstruction device according to the first embodiment with the three-dimensional information and the target object existing in the real space;

FIG. 4 is a diagram schematically showing another example of the arrangement of the plurality of sensors that provide the three-dimensional reconstruction device according to the first embodiment with the three-dimensional information and the target object existing in the real space;

FIG. 5 is a functional block diagram schematically showing a configuration of the three-dimensional reconstruction device according to the first embodiment;

FIG. 6 is a diagram showing an example of a hardware configuration of the three-dimensional reconstruction device according to the first embodiment;

FIG. 7 is a flowchart showing an operation of the three-dimensional reconstruction device according to the first embodiment;

FIG. 8 is a flowchart showing a three-dimensional information reconstruction operation in FIG. 7;

FIG. 9 is a diagram schematically showing an example of arrangement of a plurality of sensors that provide a three-dimensional reconstruction device according to a second embodiment with the three-dimensional information as the real space information and a target object existing in the real space;

FIG. 10 is a schematic diagram showing a configuration example of an unmanned moving apparatus;

FIG. 11 is a functional block diagram schematically showing the configuration of the unmanned moving apparatus shown in FIG. 10;

FIG. 12 is a functional block diagram schematically showing a configuration of the three-dimensional reconstruction device according to the second embodiment;

FIG. 13 is a flowchart showing an operation of the three-dimensional reconstruction device according to the second embodiment;

FIG. 14 is a flowchart showing a three-dimensional information reconstruction operation in FIG. 13;

FIG. 15 is a schematic diagram showing another configuration example of the unmanned moving apparatus; and

FIG. 16 is a functional block diagram schematically showing the configuration of the unmanned moving apparatus shown in FIG. 15.

### DETAILED DESCRIPTION OF THE INVENTION

A three-dimensional reconstruction device, a three-dimensional reconstruction system, a three-dimensional reconstruction method and a three-dimensional reconstruction program according to each embodiment of the present invention will be described below with reference to the drawings. The following embodiments are just examples and a variety of modifications are possible within the scope of the present invention. Further, it is possible to appropriately combine the configurations of the following embodiments.

### First Embodiment

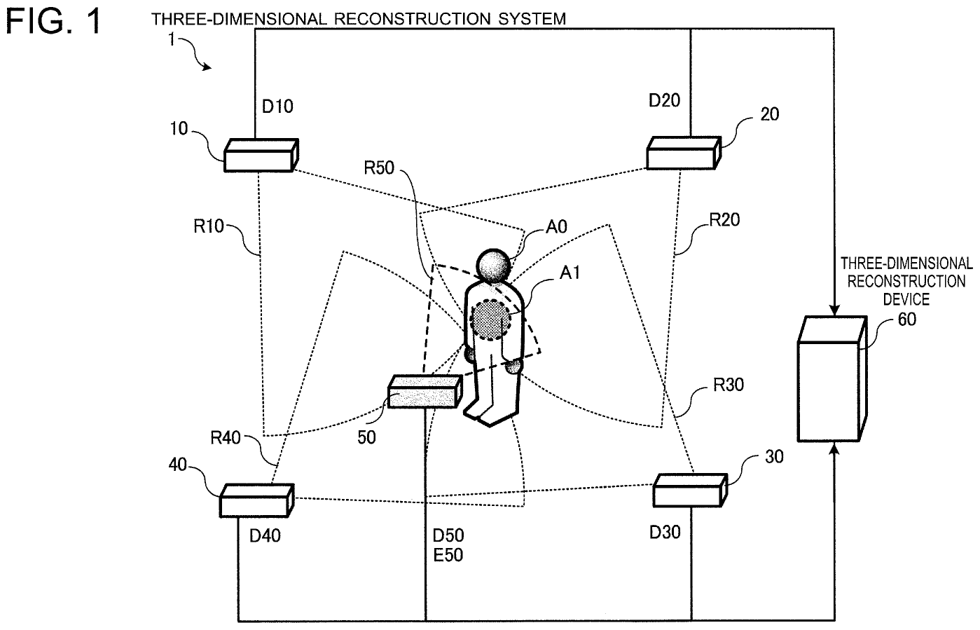

FIG. 1 is a diagram schematically showing an example of arrangement of a plurality of sensors 10, 20, 30, 40 and 50 that provide a three-dimensional reconstruction device 60 according to a first embodiment with three-dimensional information as real space information and a target object A0 existing in real space. The three-dimensional reconstruction device 60 generates integrated spatial information by integrating a plurality of pieces of real space information acquired by the sensors 10, 20, 30, 40 and 50. Put another way, the three-dimensional reconstruction device 60 reconstructs integrated three-dimensional information by integrating a plurality of pieces of three-dimensional information acquired by the sensors 10, 20, 30, 40 and 50. The three-dimensional reconstruction device 60 and the sensors 10, 20, 30, 40 and 50 constitute a three-dimensional reconstruction system 1.

Each sensor 10, 20, 30, 40, 50 is a device that acquires information regarding the real space. The sensors 10, 20, 30, 40, 50 are capable of acquiring depth information indicating the distance from the sensors 10, 20, 30, 40, 50 to a target object A0. The sensors 10, 20, 30, 40, 50 are depth cameras, for example. Each sensor 10, 20, 30, 40, 50 is referred to also as a motion capture device. A measurement principle used by the sensors 10, 20, 30, 40 and 50 is TOF (Time Of Flight), for example. However, the measurement principle used by the sensors 10, 20, 30, 40 and 50 can be any measurement principle as long as three-dimensional information representing the real space information can be generated.

The sensors 10, 20, 30 and 40 are arranged at predetermined positions. The sensors 10, 20, 30 and 40 are referred to also as “first sensors”. Each of the sensors 10, 20, 30 and 40 is, for example, a sensor fixed to a ceiling, a wall, a different structure or the like. Each sensor 10, 20, 30, 40 measures the distance to a surface of an object existing in its detection range R10, R20, R30, R40. For example, each sensor 10, 20, 30, 40 detects the target object A0 and thereby generates three-dimensional information D10, D20, D30, D40 as real space information representing the target object A0. The three-dimensional information D10, D20, D30, D40 is referred to also as “first three-dimensional information”. In FIG. 1, the target object A0 is a worker. However, the target object A0 can also be a machine in operation, a product that is moving, an article in the middle of processing, or the like. Further, the number of the sensors arranged at predetermined positions is not limited to four but can be a number other than four.

The sensor 50 is provided to be movable. The sensor 50 is referred to also as a “second sensor”. The sensor 50 is a sensor whose position can be changed, a sensor whose posture can be changed, or a sensor whose position and posture can be changed. The position and the posture of the sensor 50 can be changed by an operator of the sensor by holding the sensor 50 and moving the sensor 50. The sensor 50 may also be mounted on a supporting device that supports the sensor 50 so that the position and the posture of the sensor 50 can be changed, and the position and the posture of the sensor 50 may be changed by the operator.

The position and the posture of the sensor 50 may also be changed not by the operator of the sensor but by a moving apparatus that changes the position and the posture of the sensor 50. For example, the sensor 50 may be mounted on a moving apparatus having an automatic tracking function of controlling its own position and posture so that the sensor 50 keeps on detecting an attention part A1. This moving apparatus can also be, for example, an unmanned vehicle, an unmanned aircraft called a “drone”, an unmanned vessel, or the like. The moving apparatus having the automatic tracking function will be described later in second and third embodiments.

The sensor 50 measures the distance to a surface of an object existing in a detection range R50. For example, the sensor 50 detects the attention part A1 of the target object A0 and thereby generates three-dimensional information D50 as real space information representing the attention part A1. The three-dimensional information D50 is referred to also as “second three-dimensional information”. The attention part A1 is a region that the sensor 50 is desired to keep on detecting. For example, in a case where the target object A0 is a worker, the attention part A1 is an article in the middle of production and being assembled by the worker's hands. In FIG. 1, the attention part A1 is drawn as a range of a predetermined size in front of and in the vicinity of the chest of the worker as the target object A0. However, the attention part A1 can also be a range at a different position and of a different size.

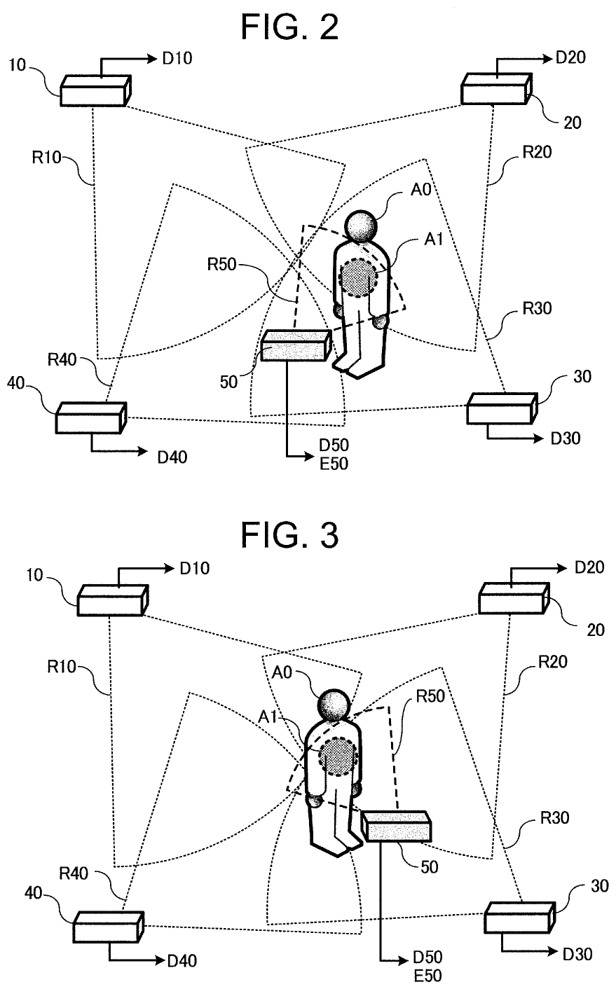

FIG. 2 is a diagram schematically showing another example of the arrangement of the plurality of sensors 10, 20, 30, 40 and 50 that provide the three-dimensional reconstruction device according to the first embodiment with the three-dimensional information as the real space information and the target object A0 existing in the real space. In FIG. 2, each component identical or corresponding to a component shown in FIG. 1 is assigned the same reference character as in FIG. 1. While the target object A0 in FIG. 1 exists in the vicinity of an intermediate position of the sensors 10, 20, 30 and 40, the target object A0 in FIG. 2 approaches the sensor 30, and consequently, the attention part A1 approaches the sensor 30 in FIG. 2. In this case, the sensor 50 keeps on detecting the attention part A1 by moving according to the movement of the attention part A1. In order to keep on detecting the attention part A1, the position, the posture, or both of the position and the posture of the sensor 50 is/are changed so that the attention part A1 remains existing in the detection range R50 of the sensor 50.

FIG. 3 is a diagram schematically showing another example of the arrangement of the plurality of sensors 10, 20, 30, 40 and 50 that provide the three-dimensional reconstruction device according to the first embodiment with the three-dimensional information as the real space information and the target object A0 existing in the real space. In FIG. 3, each component identical or corresponding to a component shown in FIG. 1 is assigned the same reference character as in FIG. 1. While the worker as the target object A0 in FIG. 1 is pointing his/her face towards the sensor 40, the worker as the target object A0 in FIG. 3 is pointing his/her face towards the sensor 30. Consequently, the attention part A1 is facing the sensor 30 in FIG. 3. In this case, the sensor 50 keeps on detecting the attention part A1 by moving according to the movement of the attention part A1. Namely, the position, the posture, or both of the position and the posture of the sensor 50 is/are changed so that the attention part A1 remains existing in the detection range R50 of the sensor 50.

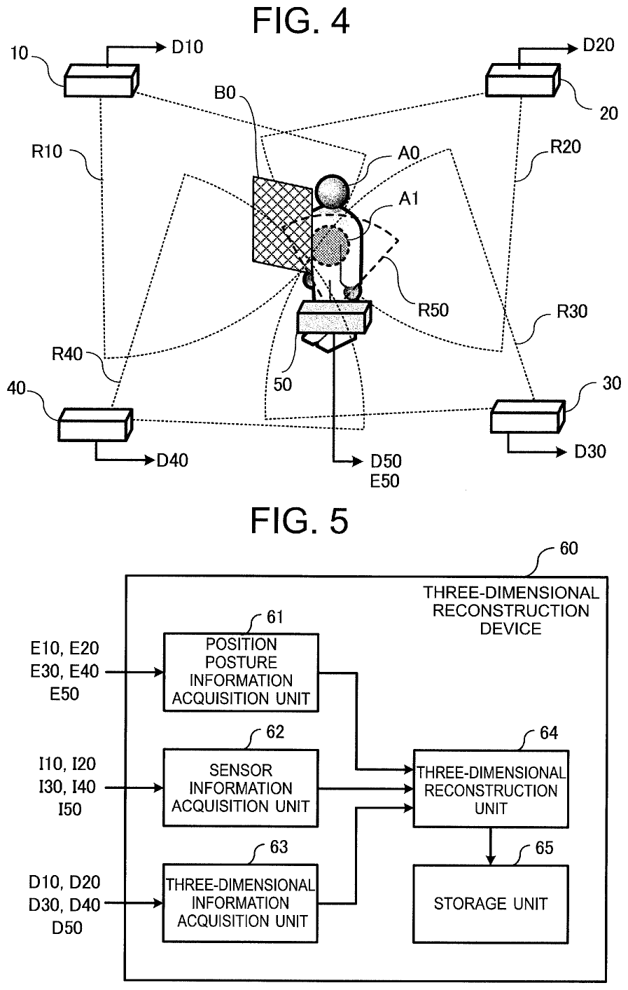

FIG. 4 is a diagram schematically showing another example of the arrangement of the plurality of sensors 10, 20, 30, 40 and 50 that provide the three-dimensional reconstruction device according to the first embodiment with the three-dimensional information as the real space information and the target object A0 existing in the real space. In FIG. 4, each component identical or corresponding to a component shown in FIG. 1 is assigned the same reference character as in FIG. 1. While no obstacle exists between the attention part A1 of the target object A0 and the sensor 50 in FIG. 1, FIG. 4 shows a state in which an obstacle BO is situated between the attention part A1 of the target object A0 and the sensor 50. In this case, the sensor 50 keeps on detecting the attention part A1 by moving depending on the position of the obstacle BO. The position, the posture, or both of the position and the posture of the sensor 50 is/are changed so that the attention part A1 remains existing in the detection range R50 of the sensor 50.

FIG. 5 is a functional block diagram schematically showing a configuration of the three-dimensional reconstruction device 60 according to the first embodiment. The three-dimensional reconstruction device 60 is a device capable of executing a three-dimensional reconstruction method according to the first embodiment. The three-dimensional reconstruction device 60 is a computer, for example.

As shown in FIG. 5, the three-dimensional reconstruction device 60 includes a position posture information acquisition unit 61, a sensor information acquisition unit 62, a three-dimensional information acquisition unit 63 and a three-dimensional reconstruction unit 64. The three-dimensional reconstruction device 60 may include a storage unit 65 as a storage device (i.e., a storage or a memory) that stores the three-dimensional information. The storage unit 65 can also be an external storage device connected to the three-dimensional reconstruction device 60.

The three-dimensional information acquisition unit 63 acquires the three-dimensional information D10, D20, D30 and D40 as the real space information from the sensors 10, 20, 30 and 40. Further, the three-dimensional information acquisition unit 63 acquires the three-dimensional information D50 as the real space information representing the attention part A1 from the sensor 50. The three-dimensional information acquisition unit 63 is desired to acquire the three-dimensional information D50 as the real space information representing the attention part A1 in real time. To acquire the three-dimensional information in real time means to acquire the three-dimensional information without executing a process of temporarily storing the three-dimensional information.

The sensor information acquisition unit 62 acquires sensor information I10, I20, I30 and I40 respectively indicating a property intrinsic to each of the sensors 10, 20, 30 and 40. The sensor information I10, I20, I30 and I40 is referred to also as “first sensor information”. The sensor information acquisition unit 62 acquires sensor information I50 indicating a property intrinsic to the sensor 50. The sensor information I50 is referred to also as “second sensor information”. The sensor information I10, I20, I30 and I40 is acquired previously. The sensor information I10, I20, I30 and I40 is previously inputted by a user operation or the like. However, the sensor information I10, I20, I30 and I40 may also be acquired from the sensors 10, 20, 30 and 40. The sensor information I50 is previously inputted by a user operation or the like. However, the sensor information I50 may also be acquired from the sensor 50.

In a case where the sensors 10, 20, 30, 40 and 50 are cameras, the sensor information I10, I20, I30, I40, I50 can include an intrinsic parameter such as the focal length of the camera.

The position posture information acquisition unit 61 acquires position posture information E10, E20, E30 and E40 respectively indicating the position and the posture of each of the sensors 10, 20, 30 and 40. The position posture information E10, E20, E30 and E40 is referred to also as “first position posture information”. The position posture information acquisition unit 61 acquires position posture information E50 indicating the position and the posture of the sensor 50. The position posture information acquisition unit 61 may also estimate the position and the posture of the sensor 50 based on movement information on the attention part (e.g., moving direction, moving distance, etc.) indicated by the three-dimensional information acquired by the sensor 50. The position posture information E50 is referred to also as “second position posture information”. The position posture information E10, E20, E30, E40 and E50 is information represented by a world coordinate system. The position posture information E10, E20, E30 and E40 is acquired previously. The position posture information E10, E20, E30 and E40 is previously inputted by a user operation or the like. However, the position posture information E10, E20, E30 and E40 may also be acquired from the sensors 10, 20, 30 and 40. The position posture information E50 is acquired from the sensor 50. The position posture information acquisition unit 61 is desired to acquire the position posture information E50 indicating the position and the posture of the sensor 50 in real time.

The position of each sensor 10, 20, 30, 40, 50 is desired to be represented by the world coordinate system. The posture of each sensor 10, 20, 30, 40, 50 is represented by a detection direction. The detection ranges (i.e., detectable ranges) R10, R20, R30, R40 and R50 of the sensors 10, 20, 30, 40 and 50 are determined from the position posture information E10, E20, E30, E40 and E50 and the sensor information I10, I20, I30, I40 and I50.

The three-dimensional reconstruction unit 64 reconstructs the three-dimensional information representing the attention part A1 from the three-dimensional information D10, D20, D30 and D40 and the three-dimensional information D50 by using the sensor information I10, I20, I30 and I40, the sensor information I50, the position posture information E10, E20, E30 and E40, and the position posture information E50. The storage unit 65 stores the three-dimensional information reconstructed by the three-dimensional reconstruction unit 64. Incidentally, the reconstructed three-dimensional information may also be outputted to a display device.

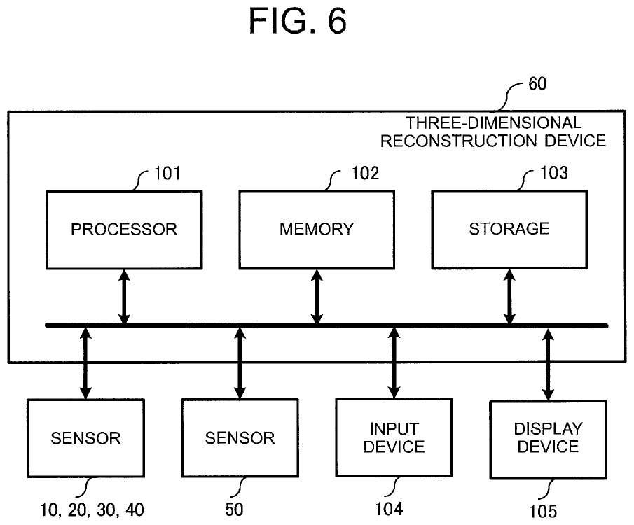

FIG. 6 is a diagram showing an example of a hardware configuration of the three-dimensional reconstruction device 60 according to the first embodiment. The three-dimensional reconstruction device 60 may be implemented by processing circuitry. The processing circuitry includes, for example, a memory 102 as a storage device that stores a program as software, namely, a three-dimensional reconstruction program according to the first embodiment, and a processor 101 as an information processing unit that executes the program stored in the memory 102. The three-dimensional reconstruction device 60 can also be a general-purpose computer. The processor 101 is an arithmetic device. The arithmetic device is a CPU (Central Processing Unit). The arithmetic device may also include a GPU (Graphics Processing Unit) in addition to the CPU. The arithmetic device may have a time provision function of providing time information.

The three-dimensional reconstruction program according to the first embodiment is stored in the memory 102 from a record medium (i.e., a non-transitory computer-readable storage medium) storing information via a medium reading device (not shown), or via a communication interface (not shown) connectable to the Internet or the like. Further, the three-dimensional reconstruction device 60 may include storage 103 as a storage device that stores various items of information such as a database. The storage 103 can be a storage device existing in the cloud and connectable via a communication interface (not shown). Furthermore, an input device 104 as a user operation unit such as a mouse and a keyboard may be connected to the three-dimensional reconstruction device 60. Moreover, a display device 105 as a display for displaying images may be connected to the three-dimensional reconstruction device 60. The input device 104 and the display device 105 can also be parts of the three-dimensional reconstruction device 60.

The position posture information acquisition unit 61, the sensor information acquisition unit 62, the three-dimensional information acquisition unit 63 and the three-dimensional reconstruction unit 64 shown in FIG. 6 can be implemented by the processor 101 executing a program stored in the memory 102. Further, the storage unit 65 shown in FIG. 5 can be a part of the storage 103.

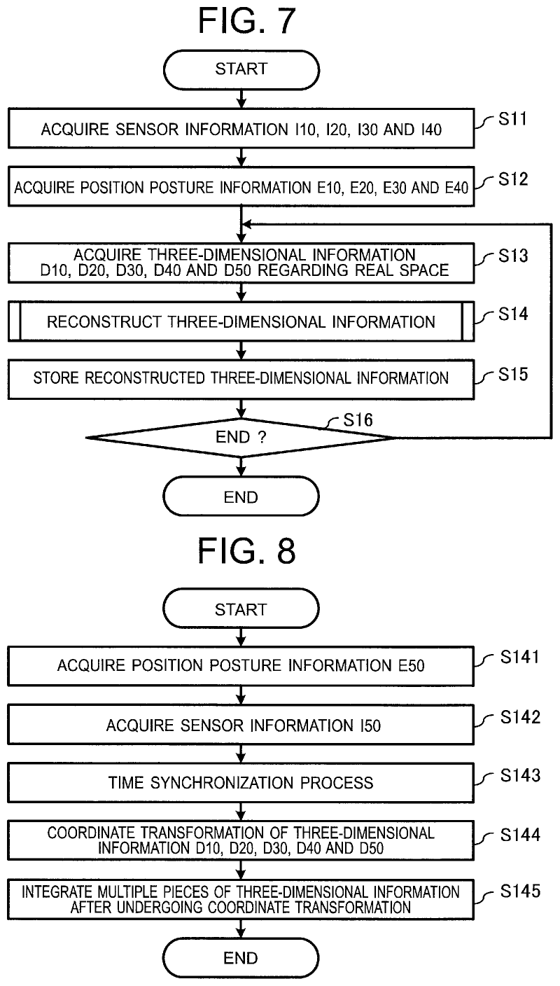

FIG. 7 is a flowchart showing an operation of the three-dimensional reconstruction device 60 according to the first embodiment. However, the operation of the three-dimensional reconstruction device 60 is not limited to the example shown in FIG. 7 and a variety of modifications are possible.

In step S11, the sensor information acquisition unit 62 acquires the sensor information I10, I20, I30 and I40 on the sensors 10, 20, 30 and 40. The sensor information I10, I20, I30, I40 is, for example, an intrinsic parameter in the sensor capable of three-dimensional measurement.

In step S12, the position posture information acquisition unit 61 acquires the position posture information E10, E20, E30 and E40 on the sensors 10, 20, 30 and 40. The position and the posture of each sensor 10, 20, 30, 40 in this case is represented by the world coordinate system.

In step S13, the three-dimensional information acquisition unit 63 acquires the three-dimensional information D10, D20, D30, D40 and D50 regarding the real space from the sensors 10, 20, 30, 40 and 50.

In step S14, the three-dimensional reconstruction unit 64 reconstructs the three-dimensional information by integrating the three-dimensional information D10, D20, D30, D40 and D50 regarding the real space by using the sensor information I10, I20, I30 and I40, the sensor information I50, the position posture information E10, E20, E30 and E40, and the position posture information E50. The three-dimensional information D10, D20, D30, D40 and D50 to be integrated are desired to be pieces of information sampled at the same time.

In step S15, the reconstructed three-dimensional information is stored in the storage unit 65. A time stamp as additional information indicating the time is assigned to the reconstructed three-dimensional information stored in the storage unit 65. The three-dimensional information to which the time stamp has been assigned can be displayed on the display device 105 shown in FIG. 6 as motion video or a still image.

The processing from the step S13 to the step S15 is repeated at constant time intervals until a termination command is inputted, for example.

FIG. 8 is a flowchart showing the operation in the step S14 as the three-dimensional information reconstruction process in FIG. 7. However, the three-dimensional information reconstruction process is not limited to the example shown in FIG. 8 and a variety of modifications are possible.

In step S141, the position posture information acquisition unit 61 acquires the position posture information E50 on the movable sensor 50.

In step S142, the sensor information acquisition unit 62 acquires the sensor information I50 on the movable sensor 50.

In step S143, the three-dimensional reconstruction unit 64 executes time synchronization of the sensors 10, 20, 30, 40 and 50. By the time synchronization, the time in each sensor 10, 20, 30, 40, 50 is synchronized with the time in the three-dimensional reconstruction device 60.

In step S144, the three-dimensional reconstruction unit 64 performs coordinate transformation for transforming the three-dimensional information represented by a point cloud (point group) in the coordinate system of each sensor 10, 20, 30, 40, 50 to three-dimensional information represented by a point cloud in the world coordinate system as a common coordinate system.

In step S145, the three-dimensional reconstruction unit 64 executes a process for integrating the three-dimensional information after undergoing the coordinate transformation. At that time, processes such as a process of deleting three-dimensional information on one side in three-dimensional information parts overlapping with each other are executed. The deletion of three-dimensional information can be executed by a publicly known method. An example of the publicly known method is a method using a voxel filter.

As described above, with the three-dimensional reconstruction device 60, the three-dimensional reconstruction system 1, the three-dimensional reconstruction method or the three-dimensional reconstruction program according to the first embodiment, the three-dimensional information can be reconstructed and stored in the storage unit 65 without lacking the information on the attention part A1. Further, even when the attention part A1 is situated in the detection range, there is a danger that the amount of the real space information drops (e.g., resolution or the like drops) in a case where the distance from the sensor to the attention part A1 is long. Nevertheless, with the three-dimensional reconstruction device 60, the three-dimensional reconstruction system 1, the three-dimensional reconstruction method or the three-dimensional reconstruction program according to the first embodiment, it is possible to not only prevent the lack of the information on the attention part A1 but also keep on continuously acquiring the three-dimensional information representing the attention part A1 in detail and the three-dimensional information representing wide space including the attention part A1.

Furthermore, the increase in the cost for the system can be inhibited since it is unnecessary in the first embodiment to add a large number of sensors along moving paths of the target object A0. Moreover, three-dimensional information representing the attention part A1 in more detail or three-dimensional information representing space including the whole of the attention part A1 can be reconstructed at a low cost.

### Second Embodiment

In the above first embodiment, the description was given of an example in which the sensors 10, 20, 30, 40 and 50 are directly connected to the three-dimensional reconstruction device 60. However, it is also possible for each sensor 10, 20, 30, 40, 50 and the three-dimensional reconstruction device to perform communication with each other via a sensor control device having a wireless communication function.

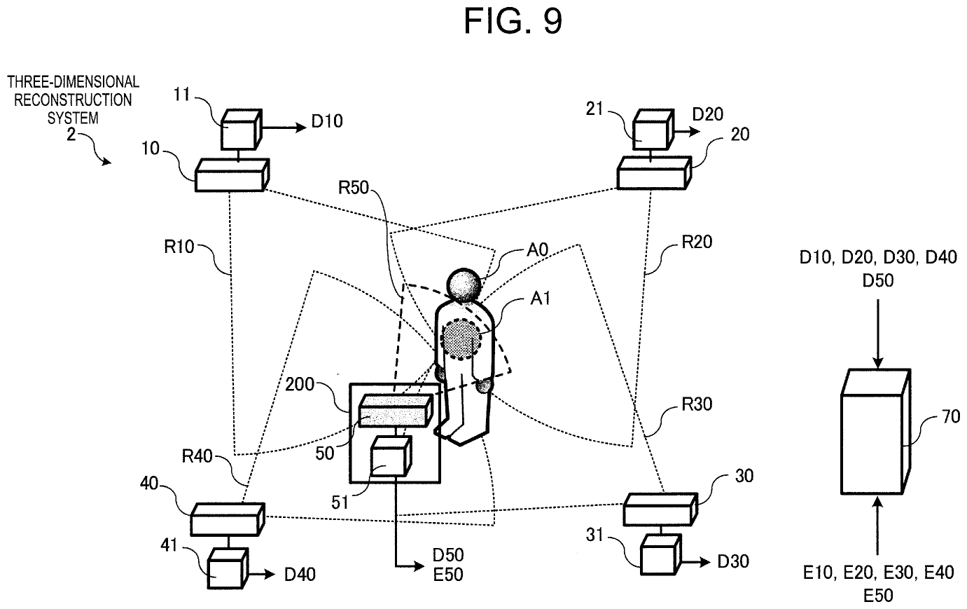

FIG. 9 is a diagram schematically showing an example of arrangement of a plurality of sensors 10, 20, 30, 40 and 50 that provide a three-dimensional reconstruction device 70 according to a second embodiment with the three-dimensional information as the real space information and target object A0 existing in the real space. In FIG. 9, each component identical or corresponding to a component shown in FIG. 1 is assigned the same reference character as in FIG. 1. The three-dimensional reconstruction device 70 is a device capable of executing a three-dimensional reconstruction method according to the second embodiment. In the second embodiment, the sensors 10, 20, 30, 40 and 50 respectively perform communication with the three-dimensional reconstruction device 70 via sensor control devices 11, 21, 31, 41 and 51. The three-dimensional reconstruction device 70, the sensors 10, 20, 30, 40 and 50, and the sensor control devices 11, 21, 31, 41 and 51 constitute a three-dimensional reconstruction system 2.

Each sensor control device 11, 21, 31, 41, 51 transmits the three-dimensional information D10, D20, D30, D40, D50 detected by the sensor 10, 20, 30, 40, 50 to the three-dimensional reconstruction device 70. Further, the sensor control device 11, 21, 31, 41, 51 may transmit the sensor information I10, I20, I30, I40, I50 and the position posture information E10, E20, E30, E40, E50 on the sensor 10, 20, 30, 40, 50 to the three-dimensional reconstruction device 70.

Furthermore, in the second embodiment, the sensor 50 and the sensor control device 51 are mounted on an unmanned moving apparatus 200 as a moving apparatus. The unmanned moving apparatus 200 can also be an unmanned vehicle, an unmanned aircraft, an unmanned vessel, an unmanned submersible ship or the like, for example. The unmanned moving apparatus 200 may also have a mechanism that changes the posture of the sensor 50. The unmanned moving apparatus 200 may also have the automatic tracking function of controlling the position and the posture of the sensor 50 based on detection information acquired by the sensor 50 so that the sensor 50 keeps on detecting the attention part A1.

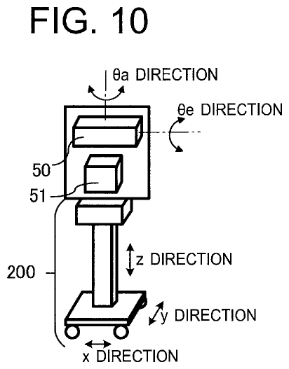

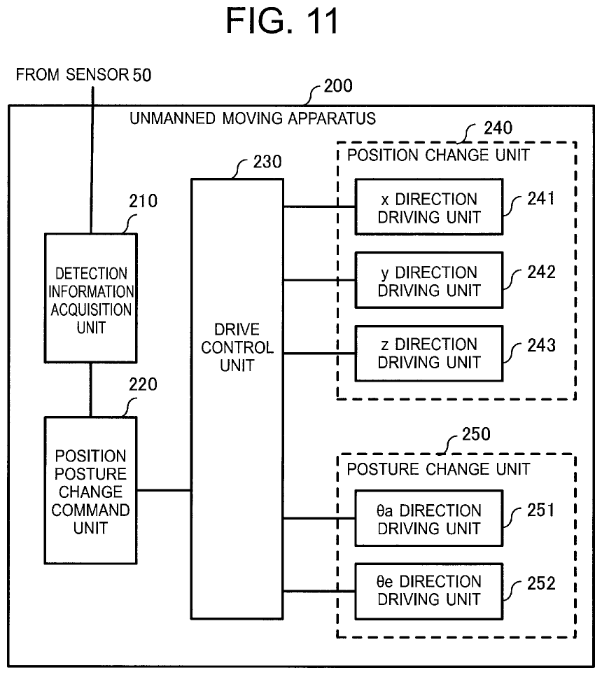

FIG. 10 is a schematic diagram showing a configuration example of the unmanned moving apparatus 200. FIG. 11 is a functional block diagram schematically showing the configuration of the unmanned moving apparatus 200. The unmanned moving apparatus 200 includes a detection information acquisition unit 210 that acquires the three-dimensional information D50 regarding the real space from the sensor 50, a position posture change command unit 220 that generates change command information regarding the position and the posture of the sensor 50 based on the three-dimensional information D50, a drive control unit 230, a position change unit 240, and a posture change unit 250. The detection information acquisition unit 210 is desired to acquire the three-dimensional information D50 in real time. The detection information acquisition unit 210 may also acquire the position posture information E50. In this case, the detection information acquisition unit 210 is desired to acquire the position posture information E50 in real time.

The position change unit 240 of the unmanned moving apparatus 200 includes an x direction driving unit 241 and a y direction driving unit 242 as traveling mechanisms traveling on a floor surface in an x direction and a y direction orthogonal to each other. Each of the x direction driving unit 241 and the y direction driving unit 242 includes wheels, a motor that generates driving force for driving the wheels, a power transmission mechanism such as gears for transmitting the driving force generated by the motor to the wheels, and so forth.

Further, the position change unit 240 includes a z direction driving unit 243 as an elevation mechanism that moves the sensor 50 up and down in a z direction. The z direction driving unit 243 includes a support table that supports components such as the sensor 50, a motor that generates driving force for moving the support table up and down, a power transmission mechanism such as gears for transmitting the driving force generated by the motor to the support table, and so forth.

The posture change unit 250 of the unmanned moving apparatus 200 includes a θa direction driving unit 251 having an azimuth angle changing mechanism that changes an azimuth angle θa of the sensor 50 and a θe direction driving unit 252 having an elevation angle changing mechanism that changes an elevation angle θe of the sensor 50. Each of the θa direction driving unit 251 and the θe direction driving unit 252 includes a motor that generates driving force for rotating the sensor 50 or its support table around a horizontal axis line or a vertical axis line, a power transmission mechanism such as gears for transmitting the driving force generated by the motor to the sensor 50 or its support table, and so forth.

For example, the position posture change command unit 220 extracts a feature point in the attention part A1 in the three-dimensional information D50 and provides the drive control unit 230 with position posture change command information for controlling the position and the posture of the sensor 50 so that the feature point does not deviate from a predetermined detection range. Incidentally, the position posture change command unit 220 may generate the change command information in consideration of the positions of the sensors 10, 20, 30 and 40. For example, the position posture change command unit 220 may permit temporary deviation of the attention part A1 from the detection range R50 of the sensor 50 when the attention part A1 is situated in one of the detection ranges R10, R20, R30 and R40 of the sensors 10, 20, 30 and 40. In this case, the unmanned moving apparatus 200 has acquired information regarding the detection ranges R10, R20, R30 and R40 of the sensors 10, 20, 30 and 40 by a preliminary input operation. The unmanned moving apparatus 200 may also include a communication device that performs communication with the sensors 10, 20, 30 and 40 for acquiring the information regarding the detection ranges R10, R20, R30 and R40 of the sensors 10, 20, 30 and 40.

The drive control unit 230 controls the position change unit 240 and the posture change unit 250 according to the received change command information.

The configurations shown in FIG. 10 and FIG. 11 are applicable also to the first embodiment. It is also possible to implement the configuration of the unmanned moving apparatus 200 shown in FIG. 11 by a memory storing a program and a processor executing the program like the configuration shown in FIG. 6.

Further, the control of the position and the posture of the sensor 50 is not limited to an inside out method but can also be executed by an outside in method. For example, the unmanned moving apparatus 200 may include an external detector that detects the position and the posture of the sensor 50 and the position posture change command unit 220 may output the position posture change command based on a detection signal from the external detector.

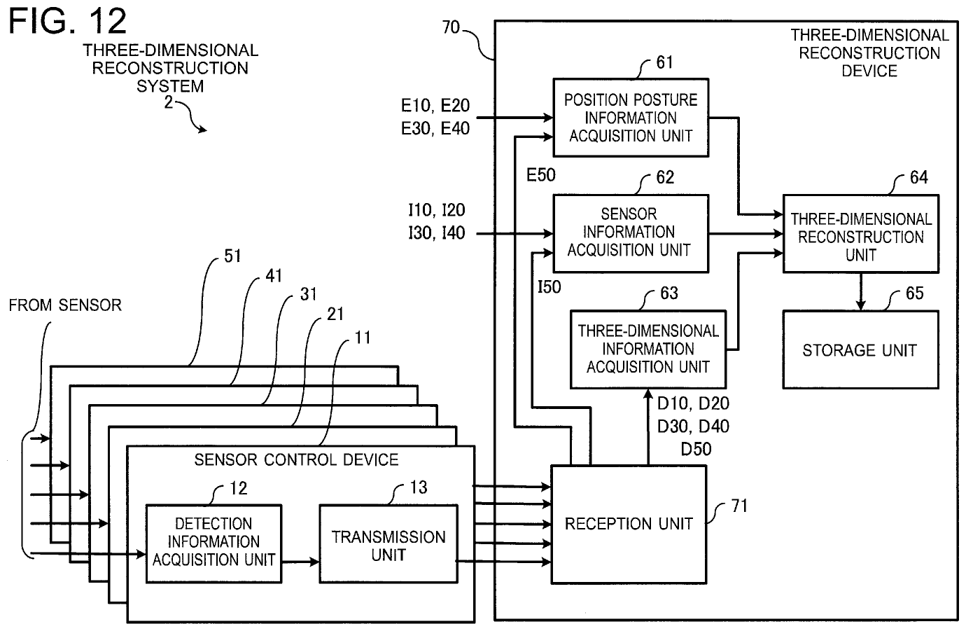

FIG. 12 is a functional block diagram schematically showing a configuration of the three-dimensional reconstruction device 70 according to the second embodiment. In FIG. 12, each component identical or corresponding to a component shown in FIG. 5 is assigned the same reference character as in FIG. 5. The three-dimensional reconstruction device 70 differs from the three-dimensional reconstruction device 60 according to the first embodiment in including a reception unit 71, i.e., a receiver. The reception unit 71 receives information transmitted from the sensors 10, 20, 30, 40 and 50 via the sensor control devices 11, 21, 31, 41 and 51.

Each of the sensor control devices 11, 21, 31, 41 and 51 includes a detection information acquisition unit 12 that acquires detection information obtained by the sensor and a transmission unit 13 that transmits information to the reception unit 71 by radio.

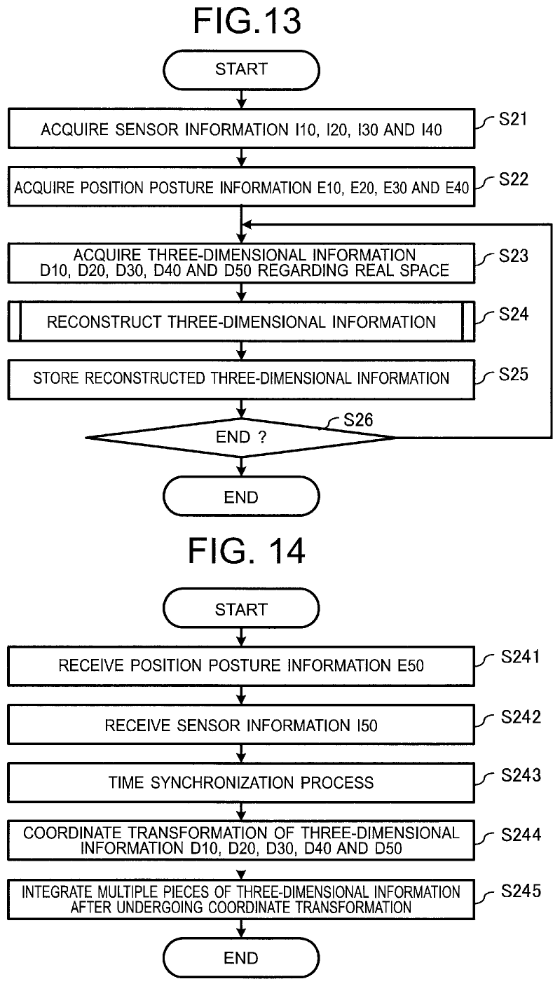

FIG. 13 is a flowchart showing an operation of the three-dimensional reconstruction device 70 according to the second embodiment. Processing in steps S21, S22 and S25 is the same as the processing in the steps S11, S12 and S15 in FIG. 7. Processing in steps S23 and S24 is the same as the processing in the steps S13 and S14 in FIG. 7. However, in the second embodiment, the three-dimensional reconstruction device 70 acquires various items of information via the reception unit 71.

In the step S23, the reception unit 71 receives the three-dimensional information D10, D20, D30, D40 and D50 regarding the real space from the sensors 10, 20, 30, 40 and 50 via the sensor control devices 11, 21, 31, 41 and 51. The three-dimensional information acquisition unit 63 acquires the three-dimensional information D10, D20, D30, D40 and D50 regarding the real space from the reception unit 71.

FIG. 14 is a flowchart showing the operation in the step S24 as the three-dimensional information reconstruction process in FIG. 13. In step S241, the reception unit 71 receives the position posture information E50 on the movable sensor 50, and the position posture information acquisition unit 61 acquires the position posture information E50 from the reception unit 71.

In step S242, the reception unit 71 receives the sensor information I50 on the movable sensor 50, and the sensor information acquisition unit 62 acquires the sensor information I50 from the reception unit 71.

Processing from step S243 to step S245 is the same as the processing from the step S143 to the step S145 in FIG. 8.

As described above, with the three-dimensional reconstruction device 70, the three-dimensional reconstruction system 2, the three-dimensional reconstruction method or the three-dimensional reconstruction program according to the second embodiment, the three-dimensional information can be reconstructed without lacking the information on the attention part A1.

Furthermore, the increase in the cost for the system can be inhibited since it is unnecessary to add a large number of sensors along moving paths of the target object A0.

Except for the above-described features, the second embodiment is the same as the first embodiment.

### Modification of Second Embodiment

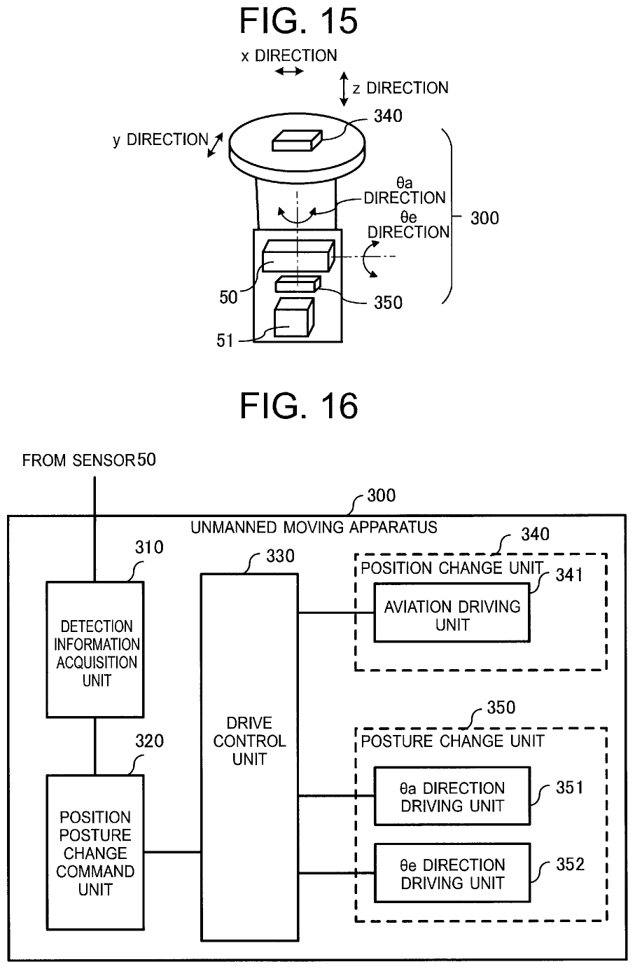

FIG. 15 is a schematic diagram showing a configuration example of an unmanned moving apparatus 300. FIG. 16 is a functional block diagram schematically showing the configuration of the unmanned moving apparatus 300. The unmanned moving apparatus 300 includes a detection information acquisition unit 310 that acquires the three-dimensional information D50 regarding the real space from the sensor 50 in real time, a position posture change command unit 320 that generates change command information regarding the position and the posture of the sensor 50 based on the three-dimensional information D50, a drive control unit 330, a position change unit 340, and a posture change unit 350.

The unmanned moving apparatus 300 includes an unmanned aircraft. The position change unit 340 of the unmanned moving apparatus 300 includes an aviation driving unit 341 for movement in the air in the x direction, the y direction and the z direction orthogonal to each other. The aviation driving unit 341 includes a propeller, a motor that generates driving force for rotating the propeller, and so forth.

The posture change unit 350 of the unmanned moving apparatus 300 includes a θa direction driving unit 351 having an azimuth angle changing mechanism that changes the azimuth angle θa of the sensor 50 and a θe direction driving unit 352 having an elevation angle changing mechanism that changes the elevation angle θe of the sensor 50. Each of the θa direction driving unit 351 and the θe direction driving unit 352 includes a motor that generates driving force for rotating the sensor 50 or its support table around a horizontal axis line or a vertical axis line, a power transmission mechanism such as gears for transmitting the driving force generated by the motor to the sensor 50 or its support table, and so forth.

For example, the position posture change command unit 320 extracts a feature point in the attention part A1 in the three-dimensional information D50 and provides the drive control unit 330 with position posture change command information for controlling the position and the posture of the sensor 50 so that the feature point does not deviate from a predetermined detection range. The drive control unit 330 controls the position change unit 340 and the posture change unit 350 according to the received change command information.

The configurations shown in FIG. 15 and FIG. 16 are applicable also to the first embodiment. It is also possible to implement the configuration of the unmanned moving apparatus 300 shown in FIG. 16 by a memory storing a program and a processor executing the program. Except for the above-described features, the example of FIG. 15 and FIG. 16 is the same as the example of FIG. 10 and FIG. 11.

Further, the unmanned moving apparatus 300 can also be an unmanned vessel that moves on the water, an unmanned submersible ship that moves in the water, an unmanned vehicle that travels on previously laid rails, or the like.

The three-dimensional reconstruction devices and the three-dimensional reconstruction systems described in the above embodiments are applicable to monitoring of work performed by a worker in a factory, monitoring of products in the middle of production, and so forth.

### DESCRIPTION OF REFERENCE CHARACTERS

1, 2: three-dimensional reconstruction system, 10, 20, 30, 40: sensor, 50: sensor, 11, 21, 31, 41, 51: sensor control device, 12: detection information acquisition unit, 13: transmission unit, 60, 70: three-dimensional reconstruction device, 61: position posture information acquisition unit, 62: sensor information acquisition unit, 63: three-dimensional information acquisition unit, 64: three-dimensional reconstruction unit, 65: storage unit, 71: reception unit, 200, 300: unmanned moving apparatus, 210, 310: detection information acquisition unit, 220, 320: position posture change command unit, 230, 330: drive control unit, 240, 340: position change unit, 250, 350: posture change unit, A0: target object, A1: attention part, D10, D20, D30, D40: three-dimensional information, D50: three-dimensional information, E10, E20, E30, E40: position posture information, E50: position posture information, I10, I20, I30, I40: sensor information, I50: sensor information, R10, R20, R30, R40: detection range, R50: detection range.

What is claimed is:

1. A three-dimensional reconstruction device comprising:
processing circuitry
to acquire first three-dimensional information representing a target object from a first sensor arranged at a predetermined position and generating the first three-dimensional information by detecting the target object that is moving and to acquire second three-dimensional information representing an attention part of the target object from a second sensor provided to be movable and generating the second three-dimensional information by detecting the attention part;
to acquire first sensor information indicating a property intrinsic to the first sensor and second sensor information indicating a property intrinsic to the second sensor;
to acquire first position posture information indicating a position and posture of the first sensor and to acquire second position posture information indicating a position and posture of the second sensor; and
to reconstruct the three-dimensional information representing the attention part from the first three-dimensional information and the second three-dimensional information by using the first sensor information, the second sensor information, the first position posture information and the second position posture information.

2. The three-dimensional reconstruction device according to claim 1, wherein the processing circuitry acquires the second three-dimensional information from the second sensor in real time.

3. The three-dimensional reconstruction device according to claim 1, wherein the processing circuitry acquires the second position posture information from the second sensor in real time.

4. The three-dimensional reconstruction device according to claim 1, further comprising a receiver that receives a radio signal, wherein
the processing circuitry acquires the second three-dimensional information from the second sensor in real time via the receiver, and
the processing circuitry acquires the second position posture information from the second sensor in real time via the receiver.

5. The three-dimensional reconstruction device according to claim 1, wherein the processing circuitry estimates the position and the posture of the second sensor based on movement information on the attention part indicated by the second three-dimensional information.

6. The three-dimensional reconstruction device according to claim 1, further comprising a storage that stores the three-dimensional information reconstructed by the processing circuitry.

7. A three-dimensional reconstruction system comprising:
a first sensor that is arranged at a predetermined position and generates first three-dimensional information representing a target object by detecting the target object that is moving;
a second sensor that is provided to be movable and generates second three-dimensional information representing an attention part of the target object by detecting the attention part; and
processing circuitry
to acquire the first three-dimensional information and the second three-dimensional information;
to acquire first sensor information indicating a property intrinsic to the first sensor and second sensor information indicating a property intrinsic to the second sensor;
to acquire first position posture information indicating a position and posture of the first sensor and to acquire second position posture information indicating a position and posture of the second sensor; and
to reconstruct the three-dimensional information representing the attention part from the first three-dimensional information and the second three-dimensional information by using the first sensor information, the second sensor information, the first position posture information and the second position posture information.

8. The three-dimensional reconstruction system according to claim 7, further comprising a movement apparatus that changes the position and the posture of the second sensor,
wherein the movement apparatus controls the position and the posture of the second sensor based on the second three-dimensional information so that the attention part does not deviate from a detection range of the second sensor.

9. The three-dimensional reconstruction system according to claim 8, wherein the movement apparatus acquires the second three-dimensional information from the second sensor in real time.

10. The three-dimensional reconstruction system according to claim 8, wherein the movement apparatus acquires the second position posture information from the second sensor in real time.

11. The three-dimensional reconstruction system according to claim 8, wherein the movement apparatus controls the movement of the second sensor in consideration of the position of the first sensor.

12. The three-dimensional reconstruction system according to claim 8, wherein the movement apparatus executes control of permitting temporary deviation of the attention part from the detection range of the second sensor when the attention part is situated in a detection range of the first sensor.

13. The three-dimensional reconstruction system according to claim 7, wherein the processing circuitry estimates the position and the posture of the second sensor based on movement of the attention part in the second three-dimensional information.

14. The three-dimensional reconstruction system according to claim 7, wherein the processing circuitry
acquires a plurality of pieces of the first three-dimensional information from a plurality of the first sensors,
acquires a plurality of pieces of the first sensor information,
acquires a plurality of pieces of the first position posture information, and
reconstructs the three-dimensional information from the plurality of pieces of the first three-dimensional information and the second three-dimensional information by using the plurality of pieces of the first sensor information, the second sensor information, the plurality of pieces of the first position posture information and the second position posture information.

15. The three-dimensional reconstruction system according to claim 7, further comprising a storage that stores the three-dimensional information reconstructed by the processing circuitry.

16. A three-dimensional reconstruction method comprising:
acquiring first three-dimensional information representing a target object from a first sensor that is arranged at a predetermined position and generates the first three-dimensional information by detecting the target object that is moving;
acquiring second three-dimensional information representing an attention part of the target object from a second sensor that is provided to be movable and generates the second three-dimensional information by detecting the attention part;
acquiring first sensor information indicating a property intrinsic to the first sensor;
acquiring second sensor information indicating a property intrinsic to the second sensor;
acquiring first position posture information indicating a position and posture of the first sensor;
acquiring second position posture information indicating a position and posture of the second sensor; and
reconstructing the three-dimensional information representing the attention part from the first three-dimensional information and the second three-dimensional information by using the first sensor information, the second sensor information, the first position posture information and the second position posture information.

17. A non-transitory computer-readable storage medium for storing a three-dimensional reconstruction program that causes a computer to execute processing comprising:
acquiring first three-dimensional information representing a target object from a first sensor that is arranged at a predetermined position and generates the first three-dimensional information by detecting the target object that is moving;
acquiring second three-dimensional information representing an attention part of the target object from a second sensor that is provided to be movable and generates the second three-dimensional information by detecting the attention part;
acquiring first sensor information indicating a property intrinsic to the first sensor;
acquiring second sensor information indicating a property intrinsic to the second sensor;
acquiring first position posture information indicating a position and posture of the first sensor;
acquiring second position posture information indicating a position and posture of the second sensor; and
reconstructing the three-dimensional information representing the attention part from the first three-dimensional information and the second three-dimensional information by using the first sensor information, the second sensor information, the first position posture information and the second position posture information.
